(19) United States
(12) Patent Application Publication
(10) Pub. No.: US 2016/0354281 A1
(43) Pub. Date: Dec. 8, 2016

(54) AUTOMATED TRANSFER OF LIQUID MEDICAMENT FROM CONTAINERS

(71) Applicants: Bryan M. O'NEILL, Holliston, MA (US); Melanie C. Cerullo, Johnston, RI (US); Paul E. Laquerre, Franklin, MA (US)

(72) Inventors: Bryan M. O'NEILL, Holliston, MA (US); Melanie C. Cerullo, Johnston, RI (US); Paul E. Laquerre, Franklin, MA (US)

(21) Appl. No.: 15/146,430

(22) Filed: May 4, 2016

Related U.S. Application Data
(60) Provisional application No. 61/157,061, filed on Mar. 3, 2009.

(51) Int. Cl. A61J 1/20; A61J 1/10; B65B 3/00; A61J 1/14

(52) U.S. Cl. CPC A61J 1/201; A61J 1/1406; A61J 1/1412; A61J 1/1443; A61J 1/10; A61J 1/2086; B65B 3/003; A61J 2205/60; A61J 2200/70

(57) ABSTRACT

In various embodiments, systems load primary drug containers into a processing apparatus in which the containers are automatically scanned for label information, sanitized, pierced, and their liquid contents aspirated out into a secondary container, such as a reservoir bag. A filtration process (e.g., a 0.2 μm filtration process) may be performed during this process, or the liquid may first be loaded into an intermediate container and filtered during transfer into another container (e.g., a second reservoir bag).

### CROSS-REFERENCE TO RELATED APPLICATION

This application claims priority to, and the benefits of, U.S. Provisional Application No. 62/157,061, filed on May 5, 2015, the entire disclosure of which is hereby incorporated by reference.

### FIELD OF THE INVENTION

The present invention relates generally to handling and dispensing pharmaceutical compositions.

### BACKGROUND

Drug manufacturers typically package liquid medicaments in sterile vials or ampoules. These “primary” containers are intended for shipment and storage; the medicament cannot be administered to a patient directly therefrom. Instead, clinicians or other personnel transfer the medicament into an adminstration device such as an IV bag, syringe, cartridge, cassette, pump, etc., or to one or more intermediate containers before final transfer to the administration device. At present, these transfer operations are performed manually—either in a controlled, aseptic environment (e.g., under a laminar flow hood) or in an uncontrolled (or less-controlled) area such as patient bedside. A clinician may, for example, sanitize each vial, withdraw the liquid with a needle/syringe, and then transfer the liquid into another container from which it may be administered. These manipulations are labor-intensive and introduce contamination risks for the drug and exposure or even biohazard risks for clinical or pharmacy personnel. A need therefore exists for a more sanitary, less labor-intensive, better-controlled system for medicament transfer.

### SUMMARY

In various embodiments, systems in accordance with the invention load primary drug containers into a processing apparatus in which the containers are automatically scanned for label information, sanitized, pierced, and their liquid contents aspirated out into a secondary container, such as a reservoir bag. The secondary container can be a final administration container (e.g., an IV bag or a syringe) from which medicament can be adminstered to a patient, or it can be an intermediate container such as reservoir bag. A filtration process (e.g., a 0.2 μm filtration process) may be performed during this process, or the liquid may first be loaded into an intermediate container and filtered during transfer into another intermediate container (e.g., a second reservoir bag) or a final administration container. The system may use a fully assembled single-use consumable set for all product contact surfaces.

Accordingly, in one aspect, the invention pertains to a method for extracting liquid from primary containers. In various embodiments, the method comprises sanitizing an exterior surface of the primary container; automatically removing a cap from the primary container to expose a septum thereon; sanitizing the septum; manipulating the primary container, via an automatic mechanical manipulator, to dispose the container proximate a needle; piercing the septum with needle; and transferring the liquid in the primary container to a reservoir bag through a filter using a pump.

In some embodiments, the method further comprises one or more of performing, as an initial step, at least one quality control task on the primary container; disposing of the vial and cap; transferring the liquid to a secondary container before transferring the liquid to the final reservoir bag; electronically scanning a primary container to identify a liquid contained therein; after the step of sanitizing the exterior surface, mechanically moving the primary container into a clean environment; automatically determining a needle penetration depth following the identification step; and/or automatically replacing the needle when it is worn.

In another aspect, the invention pertains to a system for extracting liquid from a primary container. In various embodiments, the system comprises a controller; a sanitizer module for sanitizing an exterior surface of the primary container; an aspiration module comprising (i) a needle, under control of the controller, for piercing a septum disposed on the primary container to a predetermined depth, and (ii) an extraction device, under control of the controller, for extracting liquid from the primary container via the needle; an adminstration container for receiving the liquid extracted from the primary container; a filter for filtering the liquid; and mechanical apparatus for moving the primary container through the sanitizer and aspiration modules.

The scanner may be an optical scanner or an RFID scanner. In some embodiments, the system further comprises a second sanitizer for sanitizing the septum. The system may also include or accommodate an intermediate container for receiving the liquid from the vial before the liquid is received in the secondary container. In various embodiments, the system further includes an automatic mechanical manipulator for manipulating the primary container relative to the needle. The system may include a scanner for detecting information affixed to the primary container, in which case the controller is responsive to the scanner and is configured to determine, based on the detected information, a penetration depth for the needle into the primary container.

In various embodiments, the extraction device is a peristaltic pump. The system may also include, in some embodiments, a transfer conduit and an air-in-line sensor for sensing air in the conduit, in which case the controller is responsive to the air-in-line sensor for operating the extraction device to eliminate air in the conduit.

As used herein, the terms “approximately,” “roughly,” and “substantially” mean ±10%, and in some embodiments, ±5%. Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

### BRIEF DESCRIPTION OF THE DRAWINGS

In the drawings, like reference characters generally refer to the same parts throughout the different views. Also, the drawings are not necessarily to scale, with an emphasis instead generally being placed upon illustrating the principles of the invention. In the following description, various embodiments of the present invention are described with reference to the following drawings, in which:

FIG. 1 illustrates a process flow in accordance with an embodiment of the invention.

FIG. 2 illustrates a representative apparatus in accordance with an embodiment of the invention.

### DETAILED DESCRIPTION

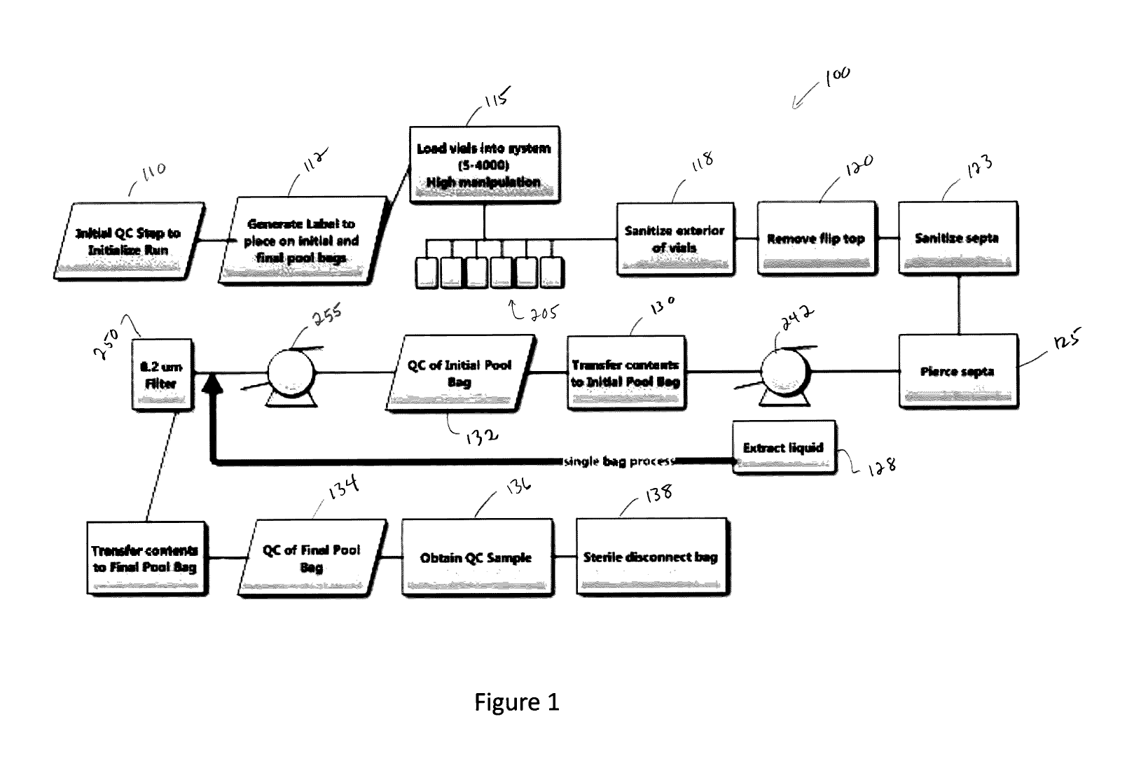

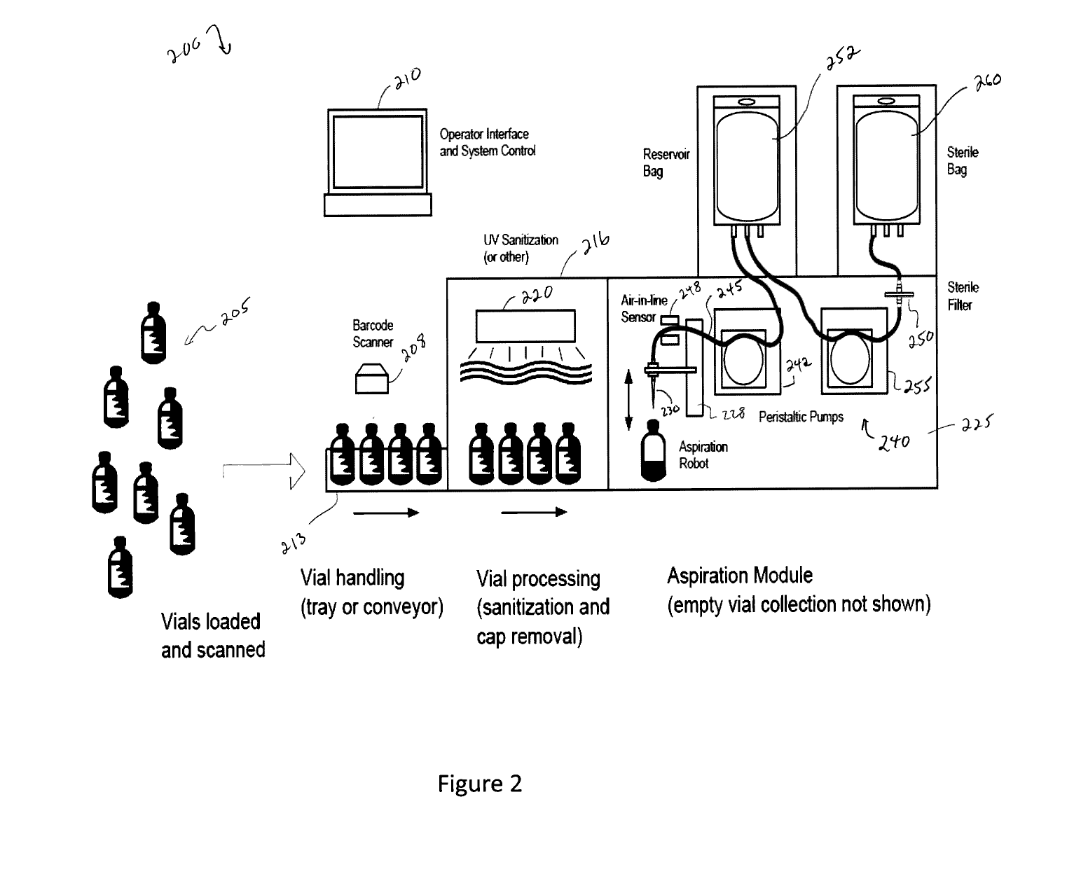

FIGS. 1 and 2 illustrate a method 100 and an apparatus 200, respectively, for automatically and aseptically evacuating liquid medicament (e.g., a drug, medicine, or other liquid) from a plurality of drug vials (or any other container, such as an ampoule) and transferring the medicament into one or more secondary containers. The system 200 is capable of processing any type of vial, including ones with different cap sizes/types and different capacities (e.g., 1 mL-5000 mL). In one embodiment, the system 200 is deployed and operated at least partially within an ISO 5 hood (having either vertical or horizontal air flow), glove box, or isolator and is sized to fit within the footprint thereof In other embodiments, the system 200 is operated in any other kind of sterile or non-sterile environment. The system 200 may be used in hospital pharmacies, similar pharmacy environments, or in any other similar setting to reduce the errors and contamination risk associated with aseptic manipulations.

### Identification of the Input Vials

In some embodiments, an initial quality-control (“QC”) step 110 is performed to initialize a run of vials 205. This QC step may include identifying some or all of the input vials using an optical or radiofrequency (RF) scanner 208. In one embodiment, the vials 205 are labeled with a barcode that represents the type of drug contained therein, its dimensions and fill volume, the date of manufacture of the liquid, the expiration date of the liquid, or any other such information (step 112). The barcode may be scanned by a barcode reader, such as the scanner 208, which may be an infrared scanner or a camera connected to a computer such as the operator-interface and system-control computer 210. In other embodiments, the vials are labelled or tagged with any other sort of identifying information or device, such as an RFID tag, an NFC tag, a 2D barcode, or simply letters and text; a scanner 208 of the appropriate type is then used to scan or read information on the vial. Indeed, an optical scanner can utilize image-recognition technology to recognize the container itself rather than an indicium thereon. In one embodiment, the connected computer 210 receives a serial or other such identifying number from the vial via the scanner 208 and then looks up (in a local or remote database) further information associated with the vial, such as its dimensions and fill volume, relevant to the transfer operation. As used herein, the term “quality control” covers all of these preliminary operations.

In some embodiments, only a subset of the vials is scanned. For example, only the first vial in a run may be scanned; the system 200 assumes thereafter that the remaining vials are of the same type as the first. In other embodiments, a vial is scanned periodically, such as every tenth vial or one vial every five minutes. In other embodiments, all vials are scanned. If a vial is scanned and is found not to match the other vials or an expected vial type, the computer 210 may halt scanning and processing entirely, divert the non-matching vial away from further processing (via manual or automatic means), and/or sound an alarm or alert.

The scanning process may be performed manually; for example, an operator may scan each vial or a subset of vials with a hand-held scanner 208 connected to the control computer 210. In other embodiments, the operator inspects each vial or a subset of vials visually. In typical implementations, however, the scanning process is automatic; a conveyor belt 213, robot arm, gravity, or similar mechanism transports the vials so they can be read by the scanner 208, which then automatically scans each vial 205 for information. Alternatively or in addition, the scanner 208 itself may be moved from vial to vial.

The control system 210 may be configured to perform additional QC tasks such as logging the date and time of processing, the identity of the operator(s), vial counts, and vial weights. The control system 210 may further generate, in physical or electronic form, labels for the one or more sterile reservoir bags used later in the process (step 112); the labels may display, for example, the drug name, concentration, current date, manufacturing date, location of scanning, or any other such information. The control system 210 may prompt the operator to place the labels on the bag(s) before it permits further processing of the vials 205. Finally, the control system 210 may also read barcodes or RFID labels on the secondary containers into which vial contents will be transferred, e.g., to ensure a proper match therebetween.

The control system 210 may be implemented by computer-executable instructions, such as program modules, being executed by a computer. Generally, program modules include routines, programs, objects, components, data structures, etc. that performs particular tasks or implement particular abstract data types. Those skilled in the art will appreciate that the invention may be practiced with various computer system configurations, including microprocessor-based electronics. The control system 210 may also be practiced in distributed computing environments where tasks are performed by remote processing devices that are linked through a communications network. In a distributed computing environment, program modules may be located in both local and remote computer storage media including memory storage devices, and a single control system 210 may control a plurality of handling systems 200.

Any suitable programming language may be used in accordance with the various embodiments of the invention. Illustratively, the programming language used may include assembly language, Ada, APL, Basic, C, C++, C*, COBOL, dBase, Forth, FORTRAN, Java, Modula-2, Pascal, Prolog, Python, REXX, and/or JavaScript, for example. Further, it is not necessary that a single type of instruction or programming language be utilized in conjunction with the operation of the system and method of the invention. Rather, any number of different programming languages may be utilized as is necessary or desirable.

The embodiments described herein can be implemented by various means, depending on application. For example, the embodiments can be implemented in hardware, firmware, software, or a combination thereof. For hardware implementation, the embodiments can be implemented with processors, controllers, microcontrollers, microprocessors, electronic devices, other electronic units designed to perform the functions described herein, or a combination thereof. Memory can be implemented within a processor or external to the processor. As used herein, the term “memory” refers to any type of long term, short term, volatile, nonvolatile, or other storage device and is not to be limited to any particular type of memory or number of memories, or type of media upon which memory is stored. For firmware and/or software implementation, the embodiments can be implemented with modules such as procedures, functions, and so on, that perform the functions described herein. Any machine readable medium tangibly embodying instructions can be used in implementing the embodiments described herein.

### Sanitizing the Vials

Medicament vials typically feature a septum, i.e., a membrane impermeable to the liquid contained therein but capable of being pierced by a needle. The septum is typically protected from exposure by a cap (typically, a flip-top cap). In one embodiment, the vials 205 are loaded onto a conveyor belt 213 (step 115) and sanitized (step 118) in a sanitizing chamber 216 prior to removal of the cap. The term “sanitizing” is herein used broadly to connote cleaning, disinfecting and/or sterilizing. The sanitizing mechanism may be, for example, a UV source 220 whose operation is govered by the control system 210. The sanitized vials are thereafter routed (e.g., by the conveyor belt 213 or other conveyance mechanism such as rollers or a robot arm) to a clean environment, such as a chamber 225 that may be, for example, the space under an ISO 5 hood. Once the vial 205 is inside the clean environment 225, its cap is opened or removed (step 120) by a robot arm or similar mechanism (and, in one embodiment, the cap is thereafter funneled into a waste container). The septum may then be sanitized (step 123) by the system, e.g., within the chamber 225. Any mode of sanitizing is within the scope of the present invention, and may include UV rays, gamma rays, a sterile isopropyl alcohol wipe or spray, ethylene oxide gas, or any other method. Sanitizing the vial 205 (with cap) and the septum (after cap removal) may be performed by the same or different types of equipment. In one embodiment, the vials 205 are sanitized outside the chamber 225 and the septa are sanitized within the chamber 225, but in other embodiments, both sanitizing operations are performed inside or outside the chamber 225. In some embodiments, sanitization occurs in a single step after or during removal of the cap.

### Piercing of the Septum

In various embodiments, the vial 205 is manipulated into a position proximate to a piercing apparatus 228 including a terminal needle 230, which is operated (or the vial 205 is manipulated) such that the needle 230 penetrates the septum of the vial 205 (step 125). The septum may, for example, be 13 mm or 20 mm in diameter. The depth of the penetration (i.e., the distance the needle 230 is moved past the exterior surface of the septum into the vial 205, as measured from the interior surface of the septum to the tip of the needle) is sufficient to extract as much volume of liquid as possible (to thereby minimize the material in the vial that is not withdrawn) but should also minimize the potential to draw air at the end of the liquid. In various embodiments, the depth of penetration is 0.5, 1, 2, or 5 mm.

The penetration depth may be the same for all vials 205, or may vary depending on the type of vial and septum (as determined in the scanning step followed by remote or local database lookup, for example). For example, if the septum is determined to be thin, the control system 210 may operate the piercing apparatus 228 so that the needle 230 penetrates to a commensurately shorter depth, while for a thicker septum the depth of penetration may be deeper. In other embodiments, the control system 210 determines the depth dynamically based on the performance of the system 200. If, for example, the control system 210 detects that air is regularly drawn during extraction of the fluid, it may increase the penetration depth; if, on the other hand, the system 200 (or an operator) detects that an unacceptable amount of fluid remains in the vial 205 when extraction is complete (via, for example, by weighing or optically scanning the vial), the depth may be decreased.

The control system 210 may determine the appropriate amount of penetration from the type of vial and knowledge of the dimensions of the piercing apparatus 228. In other embodiments, the penetration depth is actively measured by optically scanning the needle and exterior surface of the septum.

The vial 205 may be manipulated (e.g., by the piercing apparatus 228) into an inverted position prior to piercing of the vial (e.g., the septum faces downward) to assist in drawing as much liquid as possible from the vial. Any means of manipulation is within the scope of the present invention, including a robot arm, twisting conveyor belt, or other such means. The inversion may occur at any point prior to piercing, including occurring before scanning or sanitizing. In some embodiments, the vial is substantially vertically inverted; in other embodiments, the vial is tilted from vertical at an angle of, for example, 1, 2, or 5 degrees. When the vial is tilted, the needle 230 may pierce the septum in an off-center location to thereby draw more liquid from the vial. More than one needle 230 may be used; any number of needles and piercing/manipulation apparatuses 228 is within the scope of the present invention. Two, three, or four vials may be loaded in parallel, for example. Liquid from the different vials may be transferred to the same bag or to different bags.

In various embodiments, the needle 230 is replaced periodically (after a certain number of piercings or after a certain amount of time) or if wear is detected. The needle 230 may be replaced, for example, after 100, 500, or 1000 piercings or after one, two, or three days of use. In one embodiment, a recommended replacement time is suggested by the manufacturer of the needle 230. The system 200 may inspect the needle via (for example) an optical scanner or camera connected to the control computer 210; replacement may occur or be prompted if a scanned image of the needle 230 shows, for example deformity, discoloring, or any other such sign of wear. In this case, the system 200 may halt further processing of the vials and/or sound an alert for the operator. Replacement of the needle 230 may be performed manually by an operator. In some embodiments, the system 200 includes one or more additional, new needles in a magazine, cartridge, or similar apparatus; if replacement of the needle 230 is scheduled or mandated by detected wear, the new needle may be replaced automatically by the system and the old needle discarded. A robot arm may be used, for example, to remove the old needle and replace it with the new one; in another embodiment, the needle itself is mounted on a robot arm capable of releasing the old needle and moving to attach the new needle.

### Extracting the liquid

Once the needle 230 has penetrated the septum of a vial, an aspiration module 240 extracts the liquid from the vial (step 128). Extraction may be performed using suction (via, e.g., a plunger), a vacuum, by gravity, by pneumatic means, by pumping a gas into the vial with a second needle, or via any other means. In one embodiment, a peristaltic pump 242 is fluidly connected to the needle 230 via tubing 245 and draws the liquid from the vial therethrough. This aspiration line 245 may be monitored by the control system 210 using an air-in-line sensor 248 to detect when the vial is empty, in which case, in one embodiment, the pump 242 reverses (or is caused to reverse by the control system 210) and dispenses sufficient volume to remove the air from the line. Similarly, the pump 242 may be used to prime some or all of the tubing 245 with liquid.

In one embodiment, the fluid is pumped through a filter 250 (such as a 0.2 μm sterilizing filter or other suitable filter, such as a particulate filter) and dispensed into a reservoir bag 252 (step 130) or other secondary container. The bag 252 may be any size (e.g., four liters), and may be made of a suitable polymeric material such as EVA or polyolefin. In other embodiments, as illustrated in FIG. 2, the fluid is first pumped into the reservoir bag 252 and a second peristaltic pump 255 pumps the fluid from the reservoir bag 252 through the filter 250 and into another (e.g., sterile) reservoir bag 260. In this embodiment, each of the two bags is two liters in volume; the bags, however, may be any size. These embodiments may permit more stable extraction of the liquid from the vial at least partly because the first pump 242 need not work against the pressure caused by the filter 250. Movement of liquid from the reservoir bag 252 to the other reservoir bag 260 may occur when the reservoir bag 252 is full, when it fills to a threshold, or continuously, and may occur directly or through a filter. A sensor may be used to detect the fill level of the reservoir bag 252 and cause transfer to the sterile bag 260 accordingly.

The above steps may be performed on any number of input vials, e.g., 5-4000 input vials; the speed of the system may be approximately ten vials per minute. Any remaining liquid in the tubing at the end of the run of vials may thereafter be pumped into the reservoir bag. QC steps may be performed throughout the process, such as taking measurements of the reservoir bag (step 132) and/or final bag(s) (step 134) and obtaining samples from the reservoir and/or final bags (step 136). The final bag is disconnected from the system in a manner to maintain the sterility of the system and bag (step 138).

The present invention is not limited to the system and method illustrated, and one of skill in the art will understand that various steps may be added, removed, or modified. Reference throughout this specification to “one example,” “an example,” “one embodiment,” or “an embodiment” means that a particular feature, structure, or characteristic described in connection with the example is included in at least one example of the present technology. Thus, the occurrences of the phrases “in one example,” “in an example,” “one embodiment,” or “an embodiment” in various places throughout this specification are not necessarily all referring to the same example. Furthermore, the particular features, structures, routines, steps, or characteristics may be combined in any suitable manner in one or more examples of the technology. The headings provided herein are for convenience only and are not intended to limit or interpret the scope or meaning of the claimed technology.

The terms and expressions employed herein are used as terms and expressions of description and not of limitation, and there is no intention, in the use of such terms and expressions, of excluding any equivalents of the features shown and described or portions thereof. In addition, having described certain embodiments of the invention, it will be apparent to those of ordinary skill in the art that other embodiments incorporating the concepts disclosed herein may be used without departing from the spirit and scope of the invention. Accordingly, the described embodiments are to be considered in all respects as only illustrative and not restrictive.

What is claimed is:

1. A method for extracting liquid from primary containers, the method comprising:
sanitizing an exterior surface of the primary container;
automatically removing a cap from the primary container to expose a septum thereon;
sanitizing the septum;
manipulating the primary container, via an automatic mechanical manipulator, to dispose the container proximate a needle;
piercing the septum with needle; and
transferring the liquid in the primary container to a reservoir bag through a filter using a pump.

2. The method of claim 1, further comprising disposing of the vial and cap.

3. The method of claim 1, further comprising transferring the liquid to a secondary container before transferring the liquid to the final reservoir bag.

4. The method of claim 1, further comprising electronically scanning a primary container to identify a liquid contained therein.

5. The method of claim 1, further comprising, after the step of sanitizing the exterior surface, mechanically moving the primary container into a clean environment.

6. The method of claim 4, further comprising determining a needle penetration depth following the identification step.

7. The method of claim 1, further comprising automatically replacing the needle when it is worn.

8. The method of claim 1, further comprising performing, as an initial step, at least one quality control task on the primary container.

9. A system for extracting liquid from a primary container, the system comprising:
a controller;
a sanitizer module for sanitizing an exterior surface of the primary container;
an aspiration module comprising:
i. a needle, under control of the controller, for piercing a septum disposed on the primary container to a predetermined depth; and
ii. an extraction device, under control of the controller, for extracting liquid from the primary container via the needle;
an adminstration container for receiving the liquid extracted from the primary container;
a filter for filtering the liquid; and
mechanical apparatus for moving the primary container through the sanitizer and aspiration modules.

10. The system of claim 9, further comprising a second sanitizer for sanitizing the septum.

11. The system of claim 9, further comprising an intermediate container for receiving the liquid from the vial before the liquid is received in the secondary container.

12. The system of claim 9, further comprising an automatic mechanical manipulator for manipulating the primary container relative to the needle.

13. The system of claim 9, further comprising a scanner for detecting information affixed to the primary container, the controller being responsive to the scanner and determining, based on the detected information, a penetration depth for the needle into the primary container.

14. The system of claim 13, wherein the scanner is an optical scanner.

15. The system of claim 13, wherein the scanner is a radiofrequency scanner.

16. The system of claim 9, wherein the extraction device is a peristaltic pump.

17. The system of claim 9, further comprising a transfer conduit and an air-in-line sensor for sensing air in the conduit, the controller being responsive to the air-in-line sensor for operating the extraction device to eliminate air in the conduit.
